(19) United States
(12) Patent Application Publication
(10) Pub. No.: US 2002/0062298 A1
(43) Pub. Date: May 23, 2002

(54) MOTOR VEHICLE INFORMATION SYSTEM HAVING A DATABASE AND A MOVABLE CONTROL ELEMENT

(76) Inventor: GUIDO MEIER-ARENDT, LANGEN (DE)

Correspondence Address: MARTIN A FARBER, 866 UNITED NATIONS PLAZA, SUITE 473, NEW YORK, NY, 10017

(21) Appl. No.: 09/190,801

(22) Filed: Nov. 11, 1998

(30) Foreign Application Priority Data
Nov. 29, 1997 (DE) 197 53 121.0

(51) Int. Cl. G06F 7/00

(52) U.S. Cl. 707/1

(57) ABSTRACT

For a motor vehicle information system (1)

having a database (2) which contains a plurality of entries which are ordered by means of a register which is superordinate to the entries,

having a control element (3), which can be activated by moving, in order to select an individual entry, and

having a display (4) for representing the information content of the entry which has been selected with the control element (3),

a detection device (5) is proposed which senses the speed of movement of the control element (3) and, when an accelerated movement is detected, switches over the display (4) from the representation of individual entries to the representation of the superordinate register. As a result, the search process is more convenient, particularly in an extensive database, because the access time is considerably shortened.

The invention relates to a motor vehicle information system having a database in accordance with the preamble of the first claim.

Motor vehicle information systems of the generic type are known for different applications. However, they usually do not provide the user with very much convenience with regard to locating an entry in the database. The more extensive the database, the more significant is this disadvantage.

For example, a user in an address database may search for a specific entry, for example the telephone number under a specific name with the initial “P”. To do this, he initially activates the motor vehicle information system and calls up the address database. After this database has been opened, the first entry is usually displayed in it. Thus, the address database may, for example, display a name with the initial “A” and an associated telephone number. By activating a control element of the motor vehicle information system, the user must then scroll through all the entries until he finds the entry he is searching for, which is extremely laborious under certain circumstances. If a database has, for example, two hundred entries or more and possibly also a further number of subentries for each initial, the user has to activate the control element for a very long time in order to arrive at the desired entry. However, a time-consuming method of operation is inconvenient. Furthermore, the described method of operation may, particularly in the case of a motor vehicle information system, cause the driver to be distracted from controlling the vehicle to an extent which is not acceptable in terms of safety.

The object of the present invention is to accelerate the search process in a motor vehicle information system having a database, and thus to increase the convenience of use of such a system.

The object is achieved by means of the features of the first claim. The dependent claims specify advantageous refinements and developments of the solution which has been found.

The solution which has been found consists, in the first instance, in the fact that, in a motor vehicle information system

having a database which contains a plurality of entries which are ordered by means of a register which is superordinate to the entries,

having a control element, which can be activated by moving, in order to select an individual entry, and

having a display for representing the information content of the entry which has been selected with the control element,

a detection device is provided which senses the speed of movement of the control element and, when an accelerated movement is detected, switches over the display from the representation of individual entries to the representation of the superordinate register.

By sensing the speed of movement of the control element and switching over the display, dependent on the detection of an accelerated movement, from the representation of individual entries to the representation of the superordinate register, it is possible to reduce drastically the number of control procedures, as a result of which the user of the motor vehicle information system is supported in his search for a specific entry in the database without having to make additional use of further control elements, and thus in a convenient manner. The proposed measure provides a significant increase in efficiency because the user can shorten the previously necessary lengthy scrolling through the database on an entry-by-entry basis by virtue of the fact that, as a result of the manner of activating the control element which has to be activated in any case, he places the display in an ordering level which is superordinate to the individual entries and in which he can quickly access an area of entries which is strictly limited in comparison with the entire data set contained in the database and in which it is therefore then extremely easy to find the desired entry. The invention accordingly leads to a significant advantage in terms of speed in searching for a specific entry, which is perceived by the user as improved convenience.

Furthermore, there is the advantage that the motor vehicle information system is placed less frequently in the limit range of its performance. When entries are being scrolled through on an entry-by-entry basis, the motor vehicle information system has to process and display larger data sets than when only short ordering features of a register have to be displayed. Thus, the solution which has been found contributes to bringing about short system response times when user entries are being acknowledged because fewer characters have to be represented per time unit. This rapid, direct reaction of the system is also felt by a user to be an improvement and increase in convenience.

In one refinement of the invention there is provision that the detection device contains a counter and a comparator, the counter receiving a counting pulse as a result of each entry which has been selected with the control element, and the comparator causing the display to switch over from the representation of individual entries to the representation of the superordinate register if a specific minimum number of successive entries has been selected within a defined time period.

Alternatively, the detection device may contain a timer, a memory and a comparator, the timer determining the time which passes, during the activation of the control element, between the scrolling operations for locating two successive entries, the memory storing the respectively determined time for a specific number of successive measurements, and the comparator causing the display to switch over from the representation of individual entries to the representation of the superordinate register if, given a specific number of successive measurements, the stored times remain in each case below a specific maximum time.

It is advantageous to configure the control element of the motor vehicle information system as a rotary actuator. In order to switch over the display from the representation of the superordinate register back to the representation of individual entries, a switch may be provided if this switching-over operation is not controlled by a timing element which automatically switches over the display from the representation of the superordinate register to the representation of individual entries after a specific time has passed. The control of the motor vehicle information system is particularly easy for the user if the aforementioned switch is arranged integrated in the control element so that the user only needs to touch or press the control element in order to perform a switching-over operation in the display.

In one particular refinement of the invention, the switching over from the representation of individual entries to the representation of the superordinate register can be triggered by simultaneously pressing and moving the control element, so that the detection device is activated by one switching procedure and is in this respect simplified in its design in that all that needs to be determined is whether the control element has moved at all.

The motor vehicle information system may be equipped with a parameter memory in which it is possible to store in a freely programmable fashion the parameters which are decisive for the switching over of the display and which

when a counter and a comparator are used in the detection device, comprise the duration of the time period and the minimum number of successive entries, and

when a timer, a memory and a comparator are used, comprise the specific number of successive measurements whose display time on the display is determined with the timer and whose measurement time is stored in the memory, and comprise the maximum time which is the maximum permissible measurement time in order to be at all relevant for the triggering of the switching-over operation in the representation on the display, and comprise the defined minimum set of measurements which must fulfill the aforesaid criterion in terms of the measurement time.

Furthermore, a control unit may be provided which, during the activation of the control element, logs and evaluates the activation dynamics over a specific time and, in the parameter memory, automatically adapts, in an optimum way, to the method of activation of the user the respective values of the parameters which are decisive for the switching over of the display.

It is advantageous to provide a sensor in the motor vehicle information system which visually and/or audibly acknowledges the switching over of the display between the representation of the superordinate register and that of individual entries. If the control element of the motor vehicle information system is designed with haptic properties, these may change as an acknowledgment signal to the user during the switching over of the display between the representation of the register and that of individual entries.

The solution which has been found will now be explained in brief with reference to five figures, of which

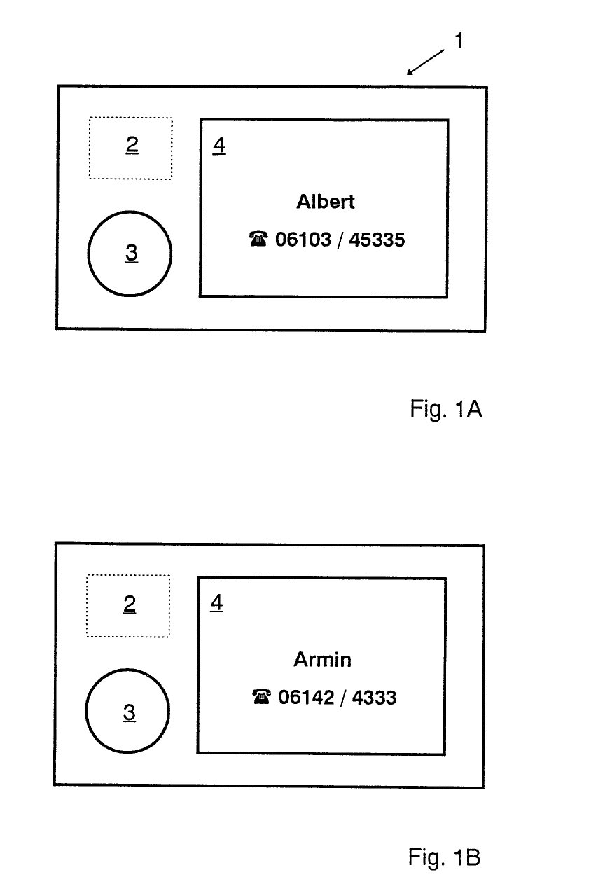

FIGS. 1A and 1B show individual entries in the database,

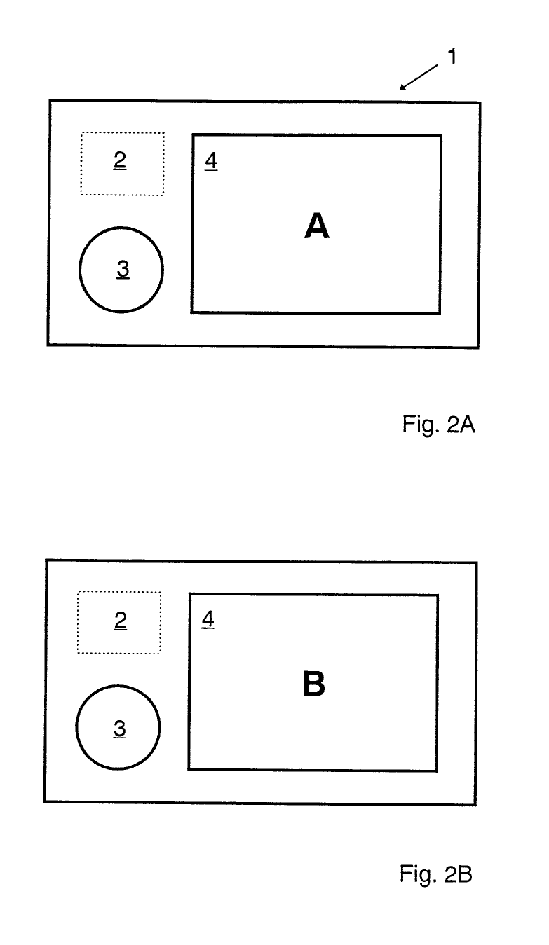

FIGS. 2A and 2B show ordering features of the register,

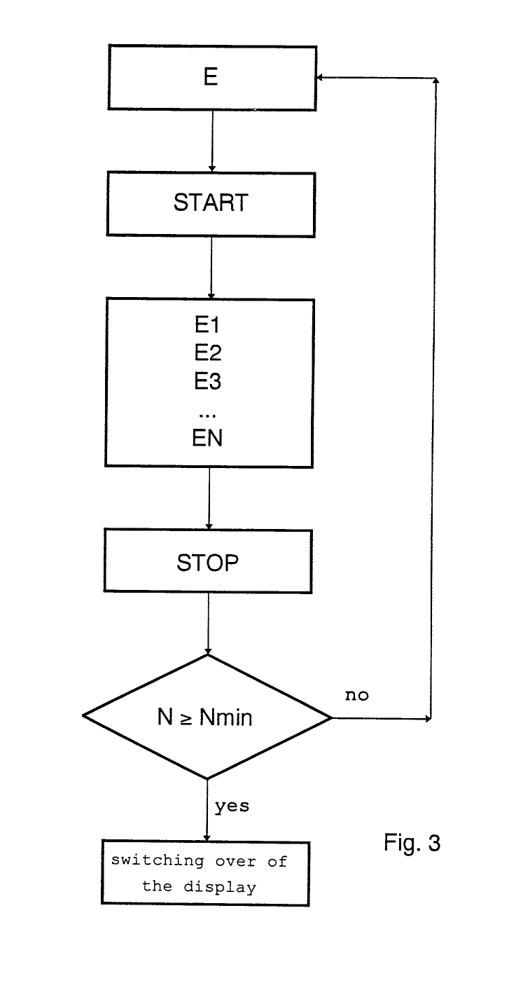

FIG. 3 shows a flow chart for switching over the display using a counter and a comparator,

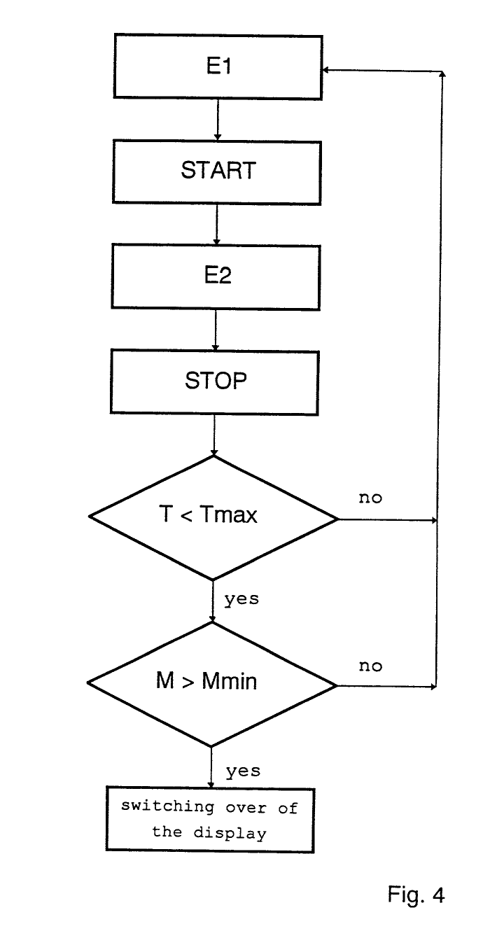

FIG. 4 shows a flow chart for switching over the display using a timer, a memory and a comparator,

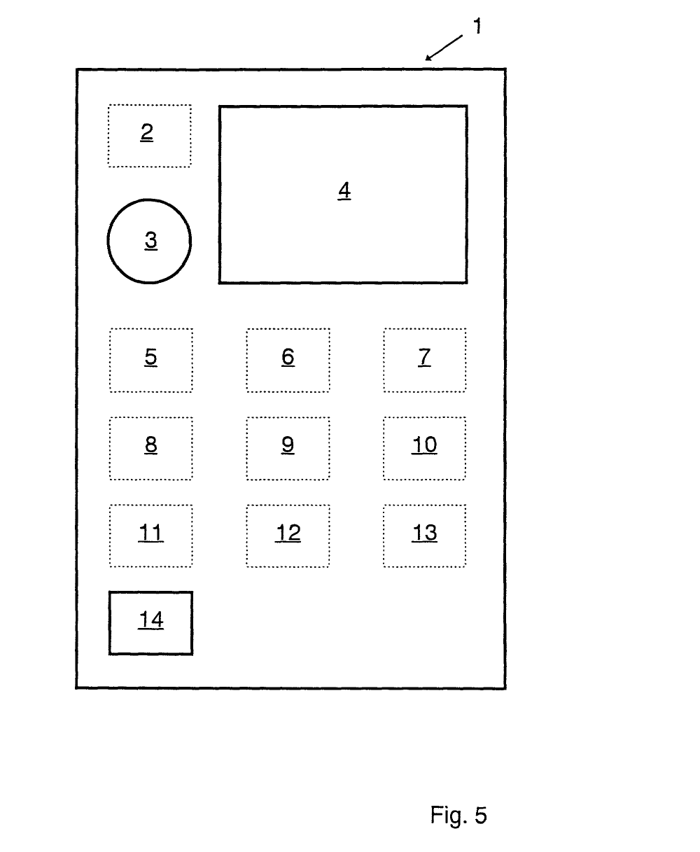

FIG. 5 shows a simplified block diagram of the features of a motor vehicle information system of the generic type which are relevant to the invention.

FIGS. 1A and 1B represent a motor vehicle information system 1 of the generic type in which a database 2 is implemented. The motor vehicle information system 1 is equipped with a control element 3 and a display 4. The control element 3 is preferably designed as a rotary actuator.

After the database 2 has been opened, a first entry, here for example “Albert— [symbol] 06103/45335” can be seen on the display 4. Activating the control element 3 causes the display 4 to scroll to the next entry in the database which is, for example, “Armin— [symbol] 06142/4333”. If the user searches for the entry “Peter— [symbol] 069/123456”, he will intuitively activate the control element 3 more quickly and thus scroll through a plurality of alphabetically ordered entries. According to the invention, the accelerated movement of the control element 3 is sensed by a detection device 5.

As soon as the detection device 5 has detected the accelerated movement of the control element 3, it causes the display 4 to switch over from the representation of individual entries to the representation of a register such as is shown in FIGS. 2A and 2B. In the example of an address database which has been selected here, it is appropriate to select the letters of the alphabet for the ordering features of the register. Therefore, after the detection of the accelerated movement of the control element 3, the display 4 switches over to the superordinate register, and during the further activation of the control element 3 said display 4 successively displays the letters of the alphabet, here “A”, “B” etc. As soon as the letter “P” is displayed in the aforesaid example of a search, the user will wish to leave the superordinate register in order to arrive at the representation of the individual entries.

It is advantageous to provide the rotary actuator with a switch 6 or key-type button in its axis of rotation so that the user only needs to touch or press the control element 3 in order to switch over the display. Even if there are subentries under the register letter “P”, for example the additional entry “Paul” with the entry's telephone number, the user then only needs to move the rotary actuator to a comparatively small degree in order to arrive at the entry “Peter— [symbol] 069/123456” which he is searching for. The switching over of the display 4 from the representation of individual entries to the representation of the superordinate register thus proves a useful measure for locating entries more quickly.

As an alternative or supplement to the switch 6, a timing element 7 may be provided which, after a specific time has passed, automatically switches over the display 4 from the representation of the register to the representation of individual entries. If the rotary actuator is not activated, for example, for a few seconds, there could be a change in the display in this way even without the user performing any action.

FIG. 3 shows a flow chart for switching over the display using a counter 8 and a comparator 9. As soon as the detection device 5 has detected a first activation result, the counter 8 starts. Here, the start of the counter 8 is triggered by a pulse E which is generated by any change in the display 4 when the entries are being scrolled through, thus, for example, at the changeover from the display of the entry “Albert” to the entry “Armin” . At any further change in the display, the counter 8 receives a further counting pulse so that, as a result of the activation of the control element 3, the counter 8 will receive a plurality of successive counting pulses E1 to EN. After a time period which is permanently programmed into the motor vehicle information system, the counter 8 stops and its counter reading N is fed to the comparator 9. If the number of counting pulses which have been received since the counter 8 started reaches or exceeds a minimum number Nmin which is permanently stored in the motor vehicle information system, the comparator 9 causes the display 4 to switch over from the representation of individual entries to the representation of the superordinate register. Otherwise, the counter reading N is reset to its starting value and the counter 8 is ready for the next counting procedure.

Alternatively, the detection device 5 may contain a timer 10, a memory 11 and, as in the previously described embodiment of the detection device 5, a comparator 9. Using these solution features, a flow chart is obtained for switching over the display in accordance with FIG. 4. The timer 10 starts when an activation result is detected. As previously described, here too, any change in the display 4 when the entries are being scrolled through should generate a pulse E. After the control element 3 has remained unactivated for a certain time, the first change in the display therefore gives rise to a pulse E1. When the next pulse E2 arrives, the timer 10 is stopped again. The timer 10 thus determines the time T which passes between two successive pulses E1 and E2 when the entries are being scrolled through as a result of the activation of the control element 3. The memory 11 has the function of buffering the respectively determined time T for a specific number K of successive measurements which have been permanently programmed into the motor vehicle information system. The comparator 9 then causes the display 4 to switch over from the representation of individual entries to the representation of the superordinate register if the stored times T associated with a specific number M of successive measurements remain in each case below a specific, predefined maximum time Tmax. From the set of stored K measurements, the previously mentioned criterion relating to the measurement time T must therefore be fulfilled at least in the case of a subset M which is greater than a defined minimum set Mmin of measurements. Otherwise, the display 4 is not switched over but instead a new measurement cycle begins.

FIG. 5 shows, once more in a simplified block diagram, all the solution features which are relevant to the invention for a motor vehicle information system of the generic type having a database. The motor vehicle information system 1 contains, as interfaces to the user, a control element 3, a display 4 and a sensor 14 which is provided for any acoustic acknowledgments when the display is switched over. As internal assemblies or functional units, the motor vehicle information system 1 contains a database 2 which contains a plurality of entries, a detection device 5 which is tailored to the activation dynamics of the control element 3, a switch 6 and a timing element 7 for resetting the display 4 from the superordinate register level to the individual entries in the database 2, a counter 8 and a comparator 9 or, alternatively, a timer 10, a memory 11 and a comparator 9, a parameter memory 12 and a control unit 13.

The parameter memory 12 contains all, or at least a substantial portion, of the parameters which are decisive for switching over the display. Depending on the embodiment of the detection device 5 these are either

the duration of the time period in which the counter 8 registers successive counting pulses E1 to EN, and the minimum number Nmin of successive entries which are necessary for switching over the display 4,

or the specific number K of successive measurements whose display time on the display 4 is determined with the timer 10 as measurement time T and is stored in the memory 11, and the maximum time Tmax which is the maximum permissible measurement time T in order to be at all relevant for the triggering of the switching-over operation in the representation on the display 4, and the defined minimum set Mmin of measurements which must fulfill the aforesaid criterion in terms of the measurement time T.

It should advantageously be possible to store these parameters in the parameter memory 12 in a freely programmable fashion.

In order to adapt individually the reaction behavior of the display 4 to the activation behavior of the user, a control unit 13 may be provided in the motor vehicle information system which, during the activation of the control element 3, logs and evaluates the activation dynamics over a specific time and then, in the parameter memory 12, automatically adapts the parameters which are decisive for the switching over of the display.

1. A motor vehicle information system (1) having a database (2) which contains a plurality of entries which are ordered by means of a register which is superordinate to the entries, having a control element (3), which can be activated by moving, in order to select an individual entry, and having a display (4) for representing the information content of the entry which has been selected with the control element (3), wherein a detection device (5) is provided which senses the speed of movement of the control element (3) and, when an accelerated movement is detected, switches over the display (4) from the representation of individual entries to the representation of the superordinate register.

2. The motor vehicle information system as claimed in claim 1, wherein the detection device (5) contains a counter (8) and a comparator (9), the counter (8) receiving a counting pulse as a result of each entry which has been selected with the control element (3), and the comparator (9) causing the display (4) to switch over from the representation of individual entries to the representation of the superordinate register if a specific minimum number of successive entries has been selected within a defined time period.

3. The motor vehicle information system as claimed in claim 1, wherein the detection device (5) contains a timer (10), a memory (11) and a comparator (9), the timer (10) determining the time which passes, during the activation of the control element (3), between the scrolling operations for locating two successive entries, the memory (11) storing the respectively determined time for a specific number of successive measurements, and the comparator (9) causing the display (4) to switch over from the representation of individual entries to the representation of the superordinate register if, given a specific number of successive measurements, the stored times remain in each case below a specific maximum time.

4. The motor vehicle information system as claimed in one of the preceding claims, wherein the control element (3) is a rotary actuator.

5. The motor vehicle information system as claimed in one of the preceding claims, wherein a switch (6) is provided with which the display (4) can be switched over from the representation of the superordinate register to the representation of individual entries.

6. The motor vehicle information system as claimed in claim 5, wherein the switch (6) is arranged integrated in the control element (3).

7. The motor vehicle information system as claimed in one of the preceding claims, wherein a timing element (7) is provided which switches over the display (4) from the representation of the superordinate register to the representation of individual entries after a specific time has passed.

8. The motor vehicle information system as claimed in claim 2 or 3, wherein a parameter memory (12) is provided in which it is possible to store in a freely programmable fashion the parameters which are decisive for the switching over of the display.

9. The motor vehicle information system as claimed in claim 8, wherein a control unit (13) is provided which, during the activation of the control element (3), logs and evaluates the activation dynamics over a specific time and, in the parameter memory (12), automatically adapts the parameters which are decisive for the switching over of the display.

10. The motor vehicle information system as claimed in one of the preceding claims, wherein a sensor (14) is provided which visually and/or audibly acknowledges the switching over of the display (4) between the representation of the superordinate register and that of individual entries.

11. The motor vehicle information system as claimed in one of the preceding claims, wherein the control element (3) has haptic properties which change during the switching over of the display (4) between the representation of the superordinate register and that of the individual entries.

12. The motor vehicle information system (1) having a database (2) which contains a plurality of entries which are ordered by means of a register which is superordinate to the entries, having a control element (3), which can be activated by moving, in order to select an individual entry, and having a display (4) for representing the information content of the entry which has been selected with the control element (3), wherein a device is provided which, when the control element (3) is simultaneously pressed and moved, switches over the display (4) from the representation of individual entries to the representation of the superordinate register.
